(19) United States
(12) Patent Application Publication
(10) Pub. No.: US 2003/0217149 A1
(43) Pub. Date: Nov. 20, 2003

(54) Method and apparatus for tunneling TCP/IP over HTTP and HTTPS

(75) Inventors: Joseph M. Crichton, Poughkeepsie, NY (US); Schuman Min Shao, Rochester, MN (US); Jeffrey W. Staten, Poughkeepsie, NY (US)

Correspondence Address: Whitham, Curtis & Christofferson, P.C., 11491 Sunset Hills Road - #340, Reston, VA, 20190, US

(73) Assignee: International Business Machines Corporation, Armonk, NY (US)

(21) Appl. No.: 10/152,281

(22) Filed: May 20, 2002

(51) Int. Cl. G06F 15/16

(52) U.S. Cl. 709/225; 709/229; 709/228

(57) ABSTRACT

A tunneling infrastructure provides TCP port forwarding from a client running on a client network to a server running on a server network, where the client and servers can be behind separate firewalls. To tunnel TCP, a “server socket” capability is provided, allowing the client to establish a connection to the server across the tunnel. A direct, port forwarding scheme is implemented. The client side is the driver for the tunnel operation. The client maintains multiple URL (Universal Resource Locator) connections to the server side tunnel allowing data to flow in both directions. The client's SendToServer connection(s) use the HTTP POST method to send data from the client side to the server side. The client's ReceiveFromServer connection(s) use the HTTP GET method, and allow data to be sent from the server side to the client side.

### BACKGROUND OF THE INVENTION

1. Field of the Invention

The present invention generally relates to packet switched network communications and, more particularly, a method and apparatus which enables arbitrary TCP/IP connectivity by a client within a “firewall”, by tunneling “inside-out” connections, using standard Web protocols.

2. Background Description

The Internet is a collection of networks throughout the world which facilitates the sharing of resources among participating organizations, including government agencies, educational institutions and private corporations. These networks use the Transmission Control Protocol/Internet Protocol (TCP/IP) protocol suite and share a common address space. Thus, computers on the Internet use compatible communications standards and share the ability to contact each other and exchange data. Users of the Internet communicate mainly via electronic mail (e-mail), via Telnet, a process that allows users to log in to a remote host, and via implementations of the File Transfer Protocol (FTP), a protocol that allows them to transfer information on a remote host to their local site. Hypertext Transfer Protocol (HTTP) is a protocol intended for quick-access, distributed, collaborative, hypermedia systems. This is the standard protocol of the World Wide Web (WWW or more simply the “Web”). HTTPS or HTTP over SSL (Secure Socket Layer) is a variant of HTTP which provides enhanced security.

Security is a major concern when connecting a network, such as a local area network (LAN) to the Internet. One of the more important concerns is intruders attempting to gain access to local hosts. A common method for preventing these types of intrusions is to install a so-called “firewall” which is a secure single point of attachment to the Internet. This single point of attachment takes the form of a firewall host or network appliance which allows only certain traffic to pass through as specified by the firewall administrator. For general information on firewalls, see William R. Cheswick and Steven M. Bellovin, Firewalls and Internet Security, Addison-Wesley (1994).

In U.S. Pat. No. 6,104,716 to Crichton et al., there is described a lightweight secure tunneling protocol that permits communicating across one or more firewalls by using a middle server or proxy. In a typical configuration, a server behind a first firewall and a client behind a second firewall are interconnected by an untrusted network (e.g., the Internet) between the firewalls. The basic system uses three proxies, one middle proxy and two end proxies, to establish an end-to-end connection that navigates through the two firewalls. A first inside firewall SOCKS-aware end server-side proxy connects to the server inside the first firewall. “SOCKS” is a transport layer proxy architecture which was created in an attempt to minimize security problems while allowing access by a large number of users. See, for example, David Koblas and Michelle R. Koblas, “SOCKS”, UNIX Security Symposium, USENIX Association (1992), pp. 77-83, and Ying-Da Lee, “SOCKS: A protocol for TCP proxy across firewalls”, http://www.socks.nec.com/socks4.protocol, and M. Leech, M. Ganis, Y. Lee, R. Kuris, D. Koblas, and L. Jones, “SOCKS Protocol Version 5”, ftp://ds.intemic.net/rfc/rfc1928.txt. The client inside the second firewall connects to a second inside firewall SOCKS-aware client-side end proxy. Both server-side and client-side end proxies can address a third proxy (called a middle proxy) outside the two firewalls. The middle proxy is usually started first, as the other two proxies (server and client end proxies) will initiate the connection to the middle proxy some time after they are started. Since the middle proxy is mutually addressable by both inside end proxies, a complete end-to-end connection between the server and client is established. It is the use of one or more middle proxies together with an appropriate protocol that establishes the secure communications link or tunnel across multiple firewalls.

While a firewall prevents “outsiders” from gaining access to resources which lie behind the firewall, for example, on a corporate intranet, in some cases, these security measures are applied broadly, both to prevent access from the outside-in, as well as the inside-out. When outbound network traffic is limited, it is typically done on a port-by-port basis. Two ports which are routinely granted a dispensation are TCP port 80 (HTTP) and TCP port 443 (HTTPS), the standard Web protocols.

The TCP protocol provides a reliable transport for communicating between two machines. An application which uses the TCP protocol via the socket programming interface, can treat a connection as a continuous, serialized, data stream. This means that bytes sent in a particular order from one side of a connection, will be received in the same order at the other end (and visa-versa). When establishing a TCP connection, the “client” will connect to the “server”. The server side is waiting for new connections by listening for them using a server socket, which is bound to a port number on an interface (machine address). Once “connected”, standard input/output (I/O) operations can be used to read and write data over that socket/TCP connection.

The challenge, then, is to somehow allow for the initiation of connections, and to transfer data content between the “client” and “server” using HTTP as the only vehicle for transport. To that end, the preferred embodiment of this disclosure has “client side” and “server side” code, which act in concert to define and establish a tunnel over which the data will traverse.

The HTTP protocol is the workhorse of the Web. Port 80 is the typical/standard port on which a Web server will listen for connections. HTTPS is less of a protocol change, and more of a semantic, where the actual protocol exchanged is still HTTP, but the connection is secured using SSL (Secure Socket Layer) encryption technology. While the present invention will work with either HTTP or HTTPS, the preferred embodiment uses HTTPS and thus provides a secure communications vehicle. This is certainly desired when data is being transmitted over the Internet.

HTTP can be thought of as a question and answer protocol in that it is synchronous, and always client driven. A client can upload data to the Web server and obtain a response using the PUT request, as well as download data by using a GET request.

The synchronous/half-duplex nature of HTTP is not naturally the best suited protocol for the tunneling of asynchronous/full-duplex TCP connections. It is interesting mostly for its ubiquitous deployment and acceptable status with respect to firewall negotiation. The HTTP protocol does allow for persistent connections, which simply means the connection from client to server can be used for more than one request/response. In HTTP 1.0, this is known as a Keep-Alive connection, while in HTTP 1.1, it is called a persistent connection. Persistent connections are the default condition for HTTP 1.1. Further, HTTP 1.1 provides support for pipelining, which helps make the communication less synchronous by allowing multiple requests to be outstanding using a single “persistent” client-to-server connection. While this does allow for reuse of the connection in a less serial nature (in the call-response sense), it has the limitation that the responses be delivered in the same order as the requests, therefore, is still serialized at the core. The big benefit here is that the server side can get the 2nd, 3rd, nth, requests, and potentially start working on them, even before finishing the 1st request, thus increasing overall throughput.

Great care has been taken to stay within the confines of the HTTP and HTTPS protocols. While it would be easy to write a custom server which owned the transfer port (80 or 443), one design goal of this invention was to provide tunneling of arbitrary TCP connections from a client endpoint to a server environment, where the server side tunneling code co-exists with current web infrastructure. In other words, the server side can run comfortably using Servlets and/or CGI escapes already assessable to today's Web environments.

### SUMMARY OF THE INVENTION

It is therefore an object of the present invention to provide a secure tunneling infrastructure to provide TCP port forwarding from a client running on a client network to a server running on a server network.

It is another object of the invention to provide a tunneling infrastructure between a client and a server, where the client and servers can be behind separate firewalls.

According to the invention, there is provided a mechanism to establish TCP communication between client applications and server resources. To tunnel TCP, a “server socket” capability is provided, allowing client applications to establish a local connection to access server resources across the tunnel. This can be done in many ways. A simple approach would be to provide standard SOCKS functionality at the client end of the tunnel, allowing socksified applications to directly address server resources on the backend, or server side. The SOCKS implementation could, as well, be reversed, to provide the serverside SOCKS access to the client “backend”. While SOCKS has become much more commonplace, there are still some applications which are not available in socksified form. Therefore, the preferred embodiment of this invention concentrates on a more direct, port forwarding scheme. The client side is the driver for the tunnel operation, just as the client/browser is the driver of a web oriented session. The client maintains multiple URL connections to the serverside tunnel allowing data to flow in both directions. The client's SendToServer connection(s) use the HTTP POST method to send data from the client side to the server side. The client's ReceiveFromServer connection(s) use the HTTP GET method, and allow data to be sent from the server side to the client side.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram illustrating the typical interaction between a client application and a server application when the client and the server are both behind a firewalls;

FIG. 2 is a block diagram showing the data flow within the client side and the server side which supports the tunneling infrastructure according to the invention;

FIG. 3 is a data flow diagram illustrating the interaction between the client and server shown in FIG. 2;

FIG. 4 is a flow diagram showing the client login sequence process;

FIG. 5 is a flow diagram showing the server login sequence process;

FIG. 6 is a flow diagram showing the SendToServer client process;

FIG. 7 is a flow diagram showing the ReceiveFromClient servlet process;

FIG. 8 is a flow diagram of the subroutine for the processing of the tunnel message;

FIG. 9 is a flow diagram showing the SendToClient servlet process;

FIG. 10 is a flow diagram showing the ReceiveFromServer client process;

FIG. 11 is a flow diagram showing the SocketOutputBuffer process thread; and

FIG. 12 is a flow diagram showing the SocketInputBuffer process thread.

### DETAILED DESCRIPTION OF A PREFERRED EMBODIMENT OF THE INVENTION

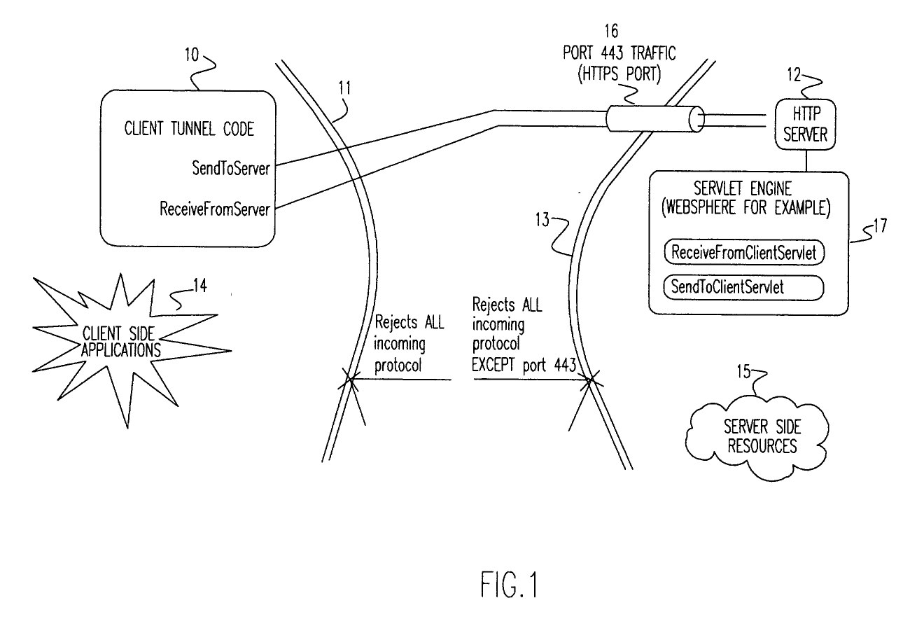

Referring now to the drawings, and more particularly to FIG. 1, there is shown an example of a client 10 behind a firewall 11 and an HTTP server 12 behind a firewall 13. The client 10 supports a plurality of client side applications 14, and the server 12 supports or has access to a plurality of resources 15. In the example illustrated, the firewall 11 rejects all incoming protocols, while the firewall 13 rejects all incoming protocol except HTTPS transfer port 443, represented here by item 16. The firewalls 111 and 13 will typically support a mechanism for passing outbound HTTP and HTTPS connections. These include SOCKS, described above, HTTPProxy and direct pass through. The HTTP server 12 incorporates a servlet engine 17. This servlet engine supports the three basic services with respect to this invention:

1. Login (establish tunnel session),

2. Receive data from the client and forward it to the appropriate server resource (ReceiveFromClientServlet), and

3. Send data collected from server resources out to the client side for dispatch to the appropriate client application (SendToClientServlet).

In the example illustrated in FIG. 1, all connections are outbound from the client side. TCP data flows from applications on the client side to resources on the server side via the SendToServer threads in the client tunnel code on repeated ReceiveFromClient servlet invocations on the server side. TCP data flows from resources on the server side to applications on the client side via the ReceiveFromServer threads in the client tunnel code from a single invocation of SendToClient servlet on the server side.

Since the goal is to move TCP data between the client and server, there must be a mechanism to establish the communication between a client and server in the first place. If the client and server were on the same LAN, with local addressability, the client would simply “connect” to the server's “listening” socket (or server socket). The server would accept the connection, the result being a TCP connection.

So, to tunnel TCP, we must provide “server socket” capability, allowing the client to establish a connection to the server across the tunnel. This can be done in many ways. One skilled in the art will recognize that a simple, and open-ended approach would be to provide standard SOCKS functionality at the client end of the tunnel, allowing “socksified” applications to directly address server resources on the back end, or server side. Limitations on what resources (addresses/ports) are accessible could easily be added (on the server side) to increase the scope of the client's capabilities. The SOCKS implementation could, as well, be reversed, to provide the server side SOCKS access to the client “back end”.

While SOCKS has become much more commonplace in the past five years, there are still some applications which are not available in “socksified” form. And there are some environments which, believe it or not, do not have a “socksified” network stack. So, the preferred embodiment of this invention concentrates on a more direct, port forwarding scheme.

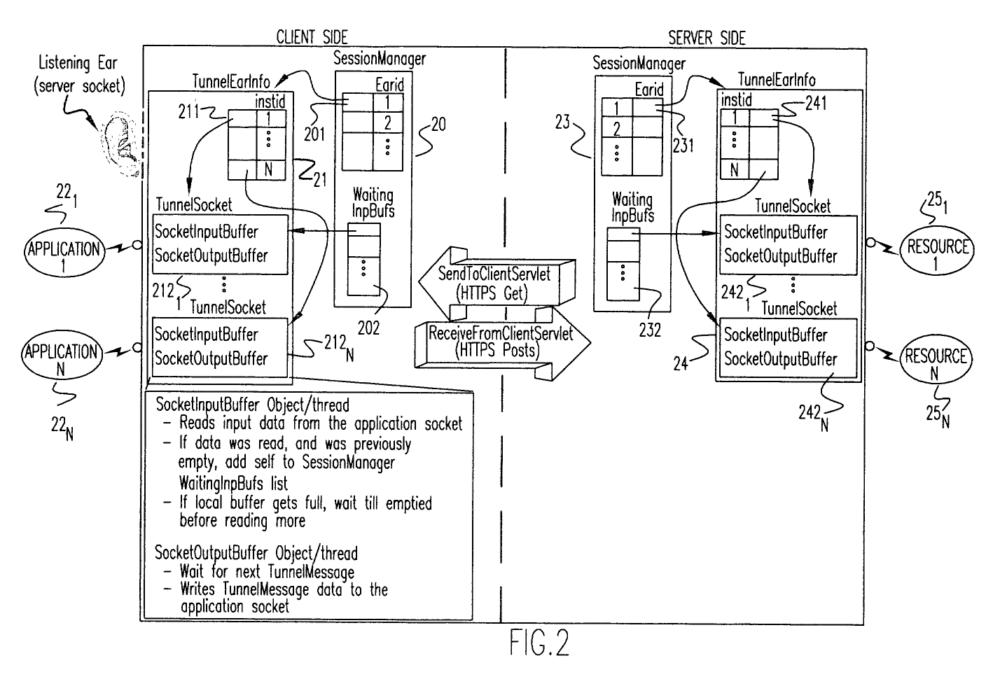

The data flow between the client and server according to the tunneling infrastructure of the present invention is shown in FIG. 2. On the client side is a session manager 20, which maintains a plurality of mappings of earid (byte value) to TunnelEarInfo object reference 201 as well as a vector of SocketInputBuffer references 202, which have data available to be forwarded to the server-side. Each TunnelEarInfo object 21, in turn, maintains a plurality of mappings 211 of instid (byte value) to TunnelSocket object reference 212, to 212ₙ, each of which supports a respective one of a plurality of applications 22₁ to 22ₙ running on the client-side. The TunnelEarInfo object can also support the creation of new TunnelSocket objects by allowing external connections to a server socket, which it maintains for that purpose (tunnel ear). Waiting SocketInputBuffer references 202 in the session manager 20 are updated by the SocketInputBuffer objects themselves 212.

Each TunnelSocket comprises a SocketInputBuffer and a SocketOutputBuffer. The SocketInputBuffer object thread reads input data from the corresponding application socket. If data was read and the local buffer was previously empty, then the SocketInputBuffer adds itself to the Waiting input buffers 202. If the local buffer becomes full, then the SocketInputBuffer object thread waits until the local buffer is emptied before reading more. The SocketOutputBuffer object thread waits for the next tunnel message and then writes the associated tunnel message data to the application socket.

The server side is similar to the client side in that it includes a session manager 23 containing a plurality of mappings of earid to TunnelEarInfo object 231, as well as a vector of SocketInputBuffer references 232, which have data available to be forwarded to the client-side. Each TunnelEarInfo object 24, in turn, maintains a plurality of mappings 241 of instid (byte value) to TunnelSocket object reference 242₁ to 242ₙ, each of which supports a respective one of a plurality of server resources 25₁ to 25ₙ accessed by the server-side of the tunnel. The TunnelEarInfo object can also support the creation of new TunnelSocket objects by allowing external connections to a server socket, which it may maintain for that purpose (tunnel ear). Waiting SocketInputBuffer references 232 in the session manager 23 are updated by the SocketInputBuffer objects themselves.

The client side is the driver for the tunnel operation, just as the client/browser is the driver of a Web-oriented session. The client maintains multiple URL (Universal Resource Locator) connections to the server-side tunnel allowing data to flow in both directions. There are two basic types of connections:

1. Data from the client headed to the server-side (SendToServer)

2. Data from the server headed to the client-side (ReceiveFromServer)

The client's SendToServer connection(s) use the HTTP POST method, as indicated by arrow 26, to send data from the client side to the server side. The client's ReceiveFromServer connection(s) use the HTTP GET method, as indicated by arrow 27, and allow data to be sent from the server side to the client side.

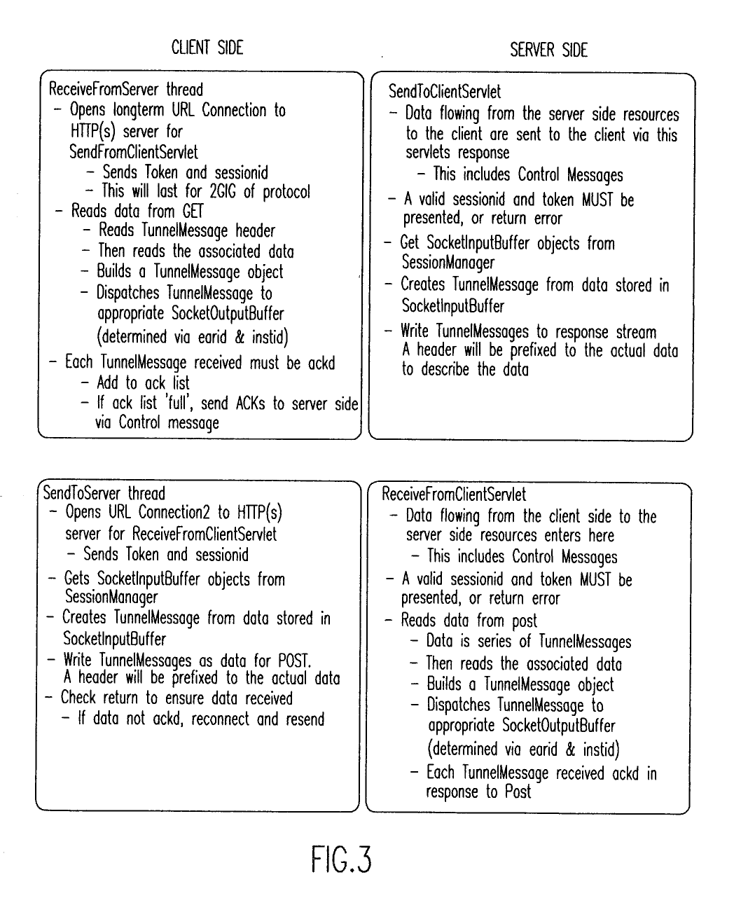

FIG. 3 is a data flow diagram illustrating the processes implemented by the tunneling method according to the invention. The process starts at the client side with the SendToServer thread. The client side opens a URL Connection to the HTTP or HTTPS server for ReceiveFromClient servlet and sends a token and session ID. On the server side, the data flowing from the client side are received, including control messages. A valid session ID and token must be received by the server, or the server returns an error. If a valid session ID and token are received, the server will process all incoming TunnelMessages embedded in the POST, and send back the appropriate acknowledgments in the response.

On the client side, SocketInputBuffer objects are retrieved from the waiting input buffers 202 of the session manager 20 (FIG. 2). A tunnel message is then created from data stored in the SocketInputBuffer. Finally, the tunnel messages are written as data for a POST request. A header will be prefixed to the actual data for each TunnelMessage.

On the server side, the data from the POST request is read. This data is a series of tunnel messages. The server reads each tunnel message header and then reads the associated data. The server then builds a tunnel message object and dispatches the tunnel message to the appropriate SocketOutputBuffer 212, or processes it if it a TunnelMessage, as determined via the earid and instid. Each tunnel message is acknowledged in response to the POST request.

The client side uses the ReceiveFromServer thread to open a long term URL connection to the HTTP or HTTPS server for the SendToClient servlet. The client sends a token and session ID to the server as HTTP parameters, which will identify the tunnel in question. The connection will remain open for the lifetime of the tunnel itself, or until 2 Gigabytes of protocol have been sent, whichever occurs first. The data flowing from the server side resources to the client are sent to the client via the SendToClient servlet's response. This data includes control messages. Again, a valid session ID and token must be received at the start of the servlet, or an error is returned by the server.

The server side (SendToClient servlet) gets SocketInputBuffer objects from the session manager 23 (FIG. 2). A tunnel message is created from the data stored in the SocketInputBuffer. Finally, tunnel messages are written to the response data stream. A header will be prefixed to the actual data to describe the data.

On the client side, the ReceiveFromServer thread reads the data from the GET request (SendToClient servlet response). First, the tunnel message header is read and then the associated data is read. A tunnel message object is built and dispatched to the SocketOutputBuffer 242, or processed as a control command as appropriate (FIG. 2). Each tunnel message received must be acknowledged. The earid, instid, and recnum for each TunnelMessage received is added to an acknowledgment list. If the acknowledge list is “full”, all acknowledges (ACKs) are sent to the server via a control message.

The notion of streaming, where a single GET request will allow a large amount of data to be returned, is employed for the ReceiveFromServer connection. In essence, a single GET request from the client can easily last for the entire tunnel lifetime, as the content-length of the response is set to a very large number (e.g., 2 Gigabytes). This allows the SSL setup and HTTP header overhead to be payed just a single time for all data which is targeted for the client (from the server). As data is accumulated for transport to the client side, the data is simply written to an appropriate and existing ReceiveFromServer response stream. The client side then simply receives the data as it arrives on the input stream from the URL connection.

Streaming for the POST request, or SendToServer connections is also desired, but current implementations of the client side browser URL connection classes (JAVA) as well as back end implementations of the Web server and/or servlet engine can prevent its use. In these cases, a multiple POST methodology must be employed. This same technique can be used for the ReceiveFromServer connection(s), as required.

In those cases where streaming cannot be employed, data will be sent to the server using a series of POST methods, as necessary, to transmit data as its accumulated. When data becomes available to be transmitted to the server side, a new URL connection will be created, and the data transmitted/embedded via the connection (as a POST). This URL connection is then disposed. The overhead for this multiple POST approach is high, as a new HTTP header will be sent for each “packet” of data which is to be sent. However, by employing keep-alive/persistent connection support, the actual overhead of establishing a new TCP connection from client to server, and negotiating the SSL handshake is minimized.

As the intent of this tunneling technology is to facilitate TCP connectivity between the client and server sides, it makes sense that a single tunnel would support multiple TCP data streams simultaneously. To accomplish this, and to capitalize on the available “bandwidth” associated with the GET and POST invocations, header information is sent with each specific TCP data packet ferried across the tunnel. This header information describes the source/destination, order, and length of the data.

The header format is as follows:

| Byte0 | Byte1 | Byte2 | Byte3 | Byte4 | Byte5 |
|---|---|---|---|---|---|
| earid | instid | recnm | len3 | len2 | len1 |

This simple header allows the tunnel to support 255 server sockets and 256 socket instances (for each of those server sockets), for a total of 65280 simultaneous end to end tunnel connections. Each server socket is assigned an earid, while each TCP socket instance is assigned an instance id (instid) unique for its associated earid. The earid 0 is used by the tunnel itself to send control messages between the tunnel endpoints.

Whenever data is available for a particular end-to-end connection, that data is prefaced with the appropriate header information. The earid/instid identifies the specific socket, the recnm specifies the relative order for this packet, and finally, the lenX bytes describe the number of bytes in the packet (in big endian order).

The recmn (record number) is assigned to a packet to keep the sequentiality of the data when more than one transport is used (SendToServer/ReceiveFromServer) as well as to facilitate recovery if these transports are broken.

When a packet arrives at an endpoint, the destination socket is accessed using the earid/instid values. The recnm is checked to see if this packet is the next to be written to said socket, and if so, the lenX amount of data is written. If this data is NOT the next in line, it is simply queued, and will be written when all preceding packets arrive and are written.

The earid 0 is reserved for use by the tunnel endpoints to pass control commands to one another. These commands allow pertinent data regarding the state of the tunnel endpoint to be shared, as well as to ask the other endpoint to provide some service.

During the normal operation of the tunnel, data for each specific socket connection is packaged with a header which includes a record number (as described above). The receiving endpoint is charged with telling the other side that the packet arrived. This “ACKing” or acknowledgment mechanism informs the sender that a particular packet can be discarded, as it will never be needed again. Essentially, the sender must save a sent packet until an acknowledgment is received, allowing it to be retransmitted in the case where it is lost in transit when http connectivity is lost.

One common threat to a TCP/IP application is the reliability of the network. When communicating from a machine on a company intranet to a specific endpoint on the Internet, many gateways, both software and hardware are traversed. A failure which severs the TCP connectivity between the client and server (TCP endpoints), will many times lead to the failure of the application. Take for example, an Xwindows application. When the connectivity between an X application and its associated X Server is severed, the application terminates, and any unsaved data (many times) is lost.

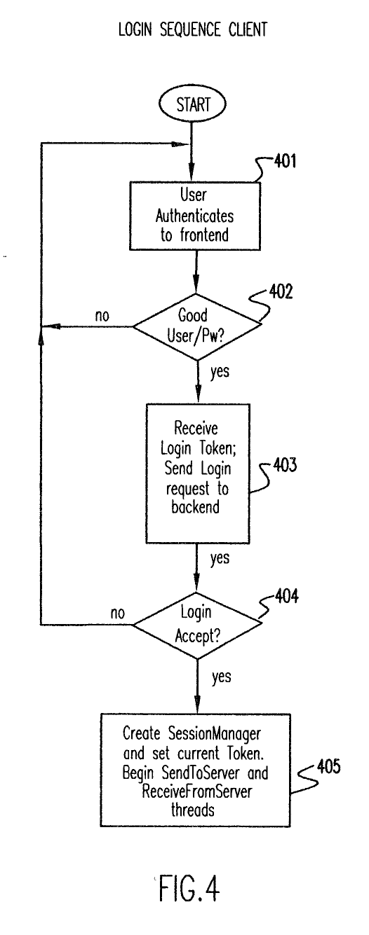

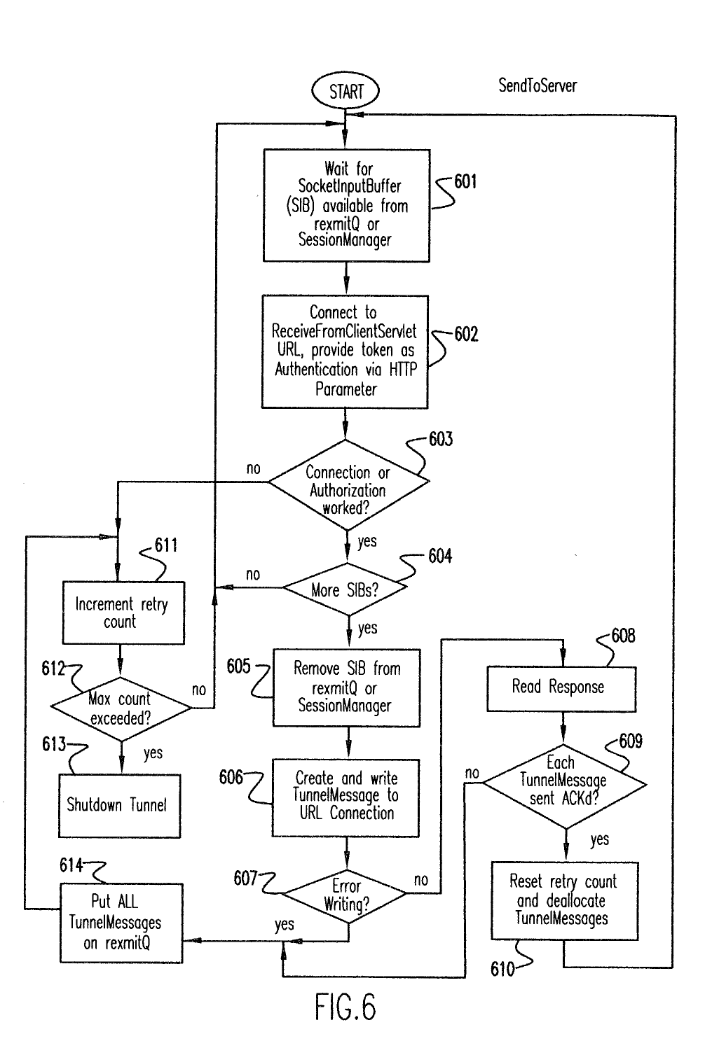

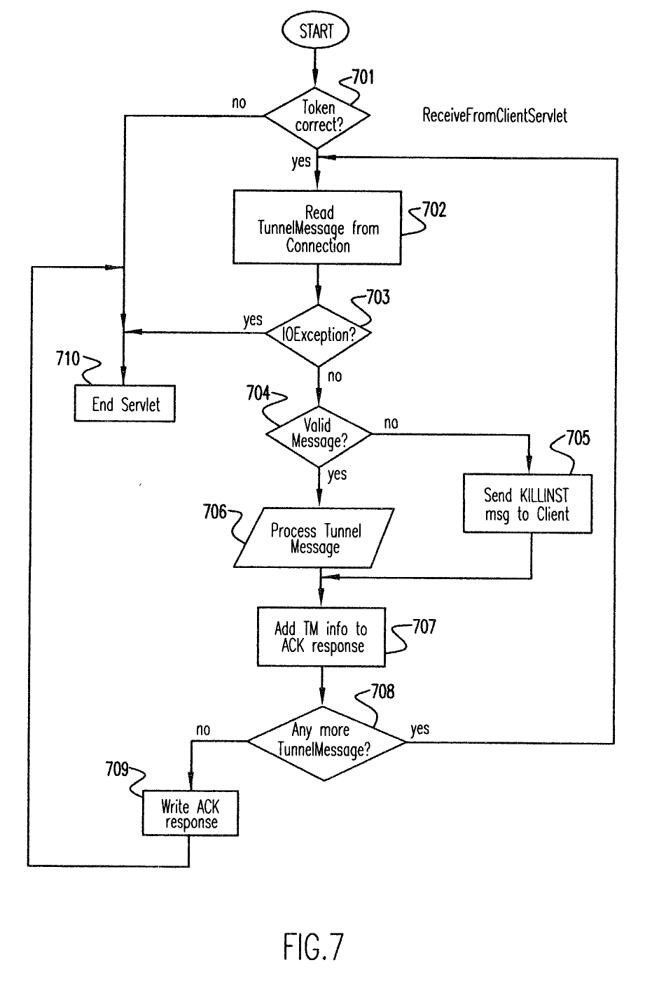

The process is more fully illustrated in the flow diagrams, to which reference is now made, beginning with FIG. 4 which shows the client login sequence process. The process begins in function block 401 where the user provides authentication to the front end. Then, in decision block 402, a determination is made as to whether the user password used in the authentication is good or not. If not, the process loops back to function block 401 to prompt the user to perform the authentication process again. This could be supplemented by a counter to allow the user only a predetermined number of tries before the session ends. When the user password is found to be good, the login token is received in function block 403 and then a login request is sent to the back end. A determination is then made in decision block 404 as to whether the login is accepted. If not, the process loops back to the function block 41 where the user is prompted to perform the authentication again. When the login is accepted, a session manager is created and the current token is set in function block 405. At this point, the SendToServer process thread, shown in FIG. 6, and the ReceiveFromServer process thread, shown in FIG. 7, are begun.

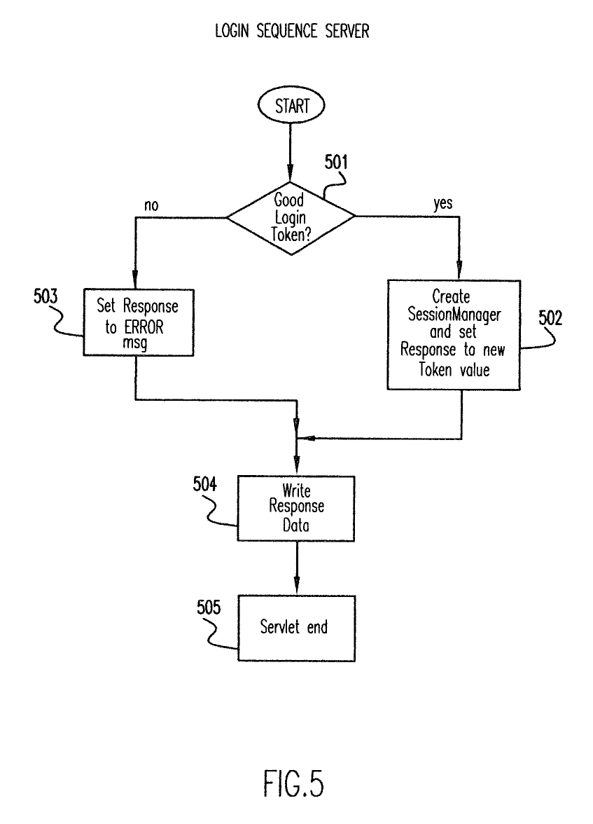

FIG. 5 shows the server login sequence. The process begins by determining in decision block 501 whether a good login token has been received from the client. If not, an error message is generated in function block 502; otherwise, the server creates a session manager and sets the response to the new token value in function block 503. In either case, response data is written in function block 504, and the servlet ends in function block 505.

FIG. 6 shows the SendToServer process thread which commences after successful client login in FIG. 4. The first step in the process is to wait for an available SocketInputBuffer from either the retransmit queue (rexmitQ) or the session manager in function block 601. Next, in function block 602, a connection is made to the ReceiveFromClient servlet (FIG. 7) URL and the token is provided as authentication to the server via the HTTP parameter. A determination is then made in decision block 603 as to whether the connection or authorization worked. If so, a determination is made in decision block 604 as to whether there are more SocketInputBuffers. If so, the next SocketInputBuffer is removed from the retransmit queue or session manager in function block 605. Next, a tunnel message is created and written to the URL connection in function block 606. A determination is made in decision block 607 as to whether an error was made in writing. If not, the response is read in function block 608. A determination is made in decision block 609 as to whether each tunnel message sent was acknowledged. If so, the retry count is reset and tunnel messages are deallocated in function block 610 before the process returns to function block 601.

Returning to decision block 603, if it is determined that the connection or authorization did not work, then the retry count is incremented in function block 611. A determination is made in decision block 612 to determine if a preset maximum count has been exceeded. If not, the process goes back to function block 601; otherwise, the process shuts down the tunnel in function block 613.

Returning to decision block 604, if there are no more SocketInputBuffers, the process goes back to function block 601. In decision block 607, if there was an error in writing, or in decision block 609, if no tunnel message acknowledgment was received, all tunnel messages are put on the retransmit queue in function block 614 before the process returns to function block 601.

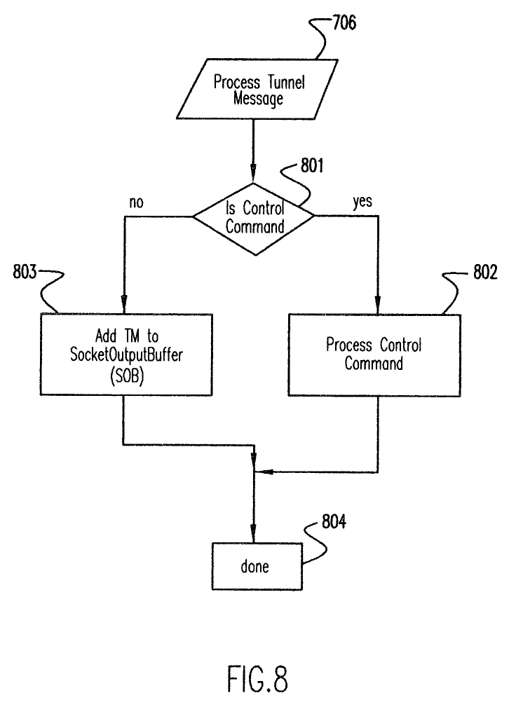

The ReceiveFromClient servlet process is shown in the flow diagram of FIG. 7. The process begins by determining in decision block 701 as to whether the correct token has been received from the client. If so, the tunnel message is read from the connection in function block 702. A determination is made in decision block 703 as to whether an input/output (I/O) exception has occurred. If not, a further test is made in decision block 704 as to whether a valid message was received. If not, a kill tunnel socket instance (KILLINST) control message is sent to the client in function block 705, and the process skips to function block 707. If, however, the message is valid, the process tunnel message subroutine is called in operation block 706. This subroutine is shown in FIG. 8, to which reference is now made.

In FIG. 8, the process tunnel subroutine is called in operation block 707, and a determination is made in decision block 801 as to whether the message is a control command. If so, the control command is processed in function block 802; otherwise, the TunnelMessage is added to the SocketOutputBuffer in function block 803. A return to the main process is then made in function block 804.

The control commands which are processed for the server-side are listed below:

KILLINST—Kills a TunnelSocket instance.

KILLEAR—Kills a TunnelEar.

NEWEAR—Request creation of a new TunnelEar.

NEWTOKEN—New authentication token arrives.

REWAPTOKEN—A request to rewrap a login token. This will refresh the timeout validity.

SHUTDOWN—Request to shut down tunnel.

SERVERPING—Returning latency check from client.

PING—Client latency check; just return it.

CONSUMPTION—Modifies consumption rate for TunnelSocket.

XON/XOFF—Controls flow from a TunnelSocket.

ACKS—Acknowledgments from client.

COMPRESS—Compression toggle for TunnelSocket.

NOOP—no operation; ignore

The control commands which are processed for the client-side are listed below:

KILLINST—Kills a TunnelSocket instance.

KILLEAR—Kills a TunnelEar.

NEWEAR—Request creation of a new TunnelEar.

NEWTOKEN—New authentication token arrives.

REWAPTOKEN_RESP LOGIN TOKEN—Response to rewraptoken request.

SHUTDOWN—Request to shut down tunnel.

SERVERPING—Server checking latency; just return it.

PING—Returning client latency check.

CONSUMPTION—Modifies consumption rate for TunnelSocket.

XON/XOFF—Controls flow from a TunnelSocket.

NOOP—No operation; ignore.

When a return has been made from the subroutine called by operation block 706, the tunnel message information is added to the acknowledge (ACK) response list in function block 707. A determination is next made in decision block 708 as whether there are any more tunnel messages. If so, the process loops back to function block 702 to read the next tunnel message; otherwise, the ACK response is written in function block 709 before the servlet is ended in function block 710.

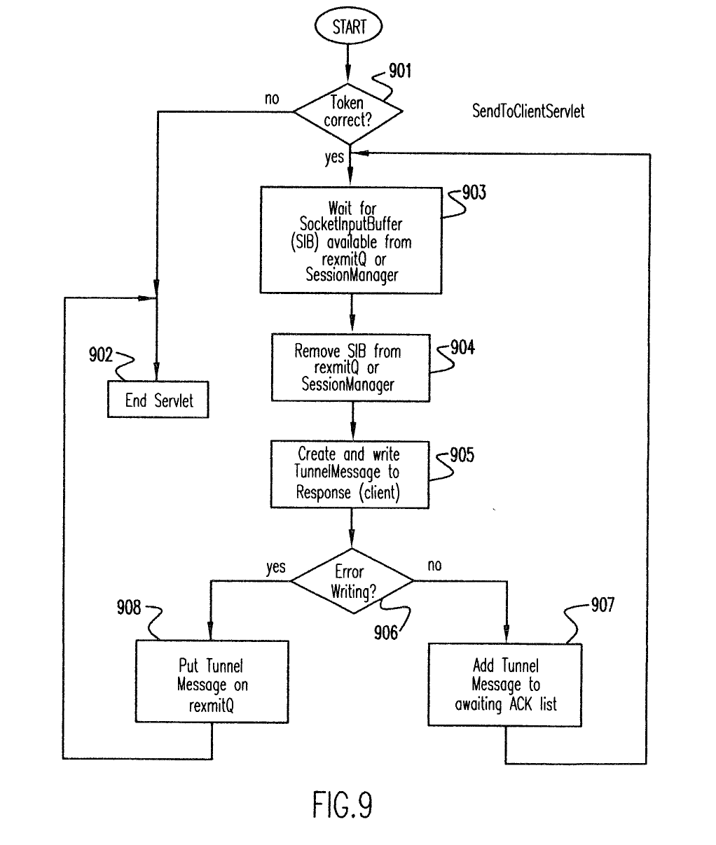

The SendToClient servlet process is shown in FIG. 9. The process begins in decision block 901 where a determination as to whether the token is correct. If not, the servlet is ended in function block 902. If, however, the token is correct, the process waits in function block 903 for an available SocketInputBuffer from the retransmit queue or the session manager. When available, a SocketInputBuffer is removed from the retransmit queue or the session manager in function block 904. Then, the tunnel message response to the client is created and written in function block 905. A test is made in decision block 906 to determine if there was an error in writing. If not, the tunnel message is added to the awaiting ACK list in function block 907, and the process goes back to function block 903. If, however, there was an error in writing, the tunnel message is put on the retransmit queue in function block 908, and then the servlet is ended in function block 902.

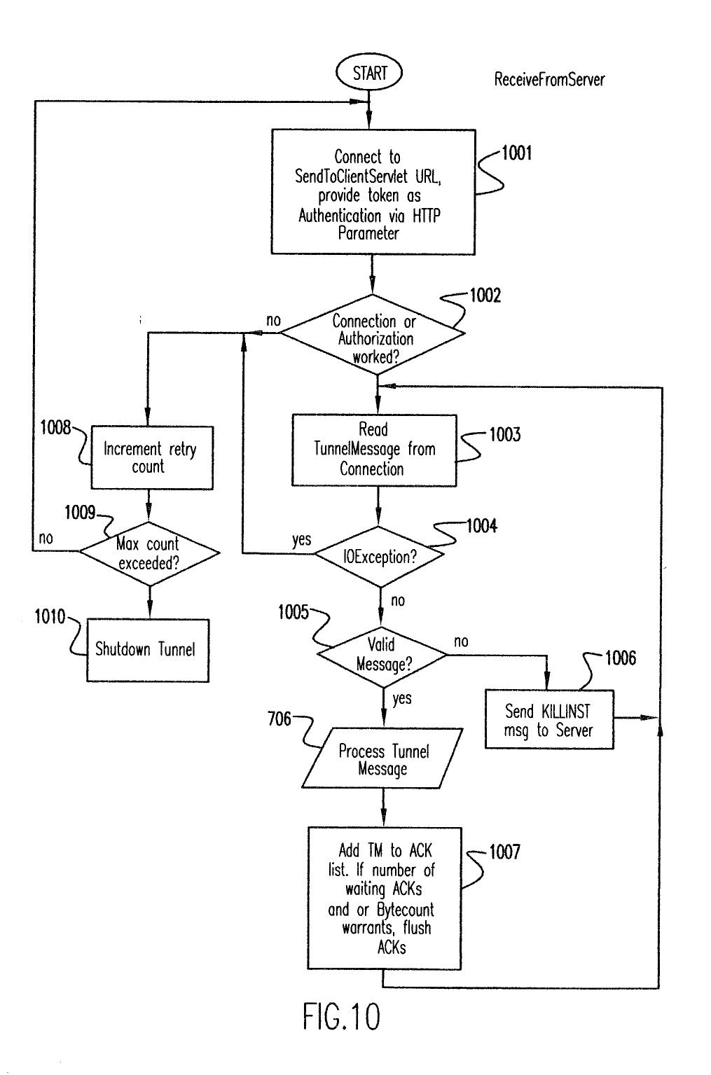

Referring now to FIG. 10, there is shown the block diagram of the ReceiveFromServer process thread. The process begins by connecting to the SendToClient servlet URL in function block 1001. A determination is then made in decision block 1002 as to whether the connection or authorization worked. If so, the tunnel message is read from the connection in function block 1003. A determination is made in decision block 1004 as to whether an input/output (I/O) exception occurred. If not, a further test is made in decision block 1005 as to whether the message is valid. If not, a kill tunnel socket instance (KILLINST) message is sent to the server in function block 1006, and returns to function block 1003. If, however, the message is valid, the process tunnel message subroutine is called in operation block 706. This process is shown in FIG. 8, described above. When a return is made from the process tunnel message subroutine, the tunnel message is added to the ACK list in function block 1007. If the number of waiting ACKs and/or Byte count warrants, the ACKs are flushed. The process then returns to function block 1003.

If in decision block 1002 the connection or authorization did not work or an I/O exception occurred in decision block 1004, then the retry count is incremented in function block 1008. A test is made in decision block 1009 to determine if a preset maximum count has been exceeded. If not, the process goes back to function block 1001; otherwise, the tunnel is shut down in function block 1010.

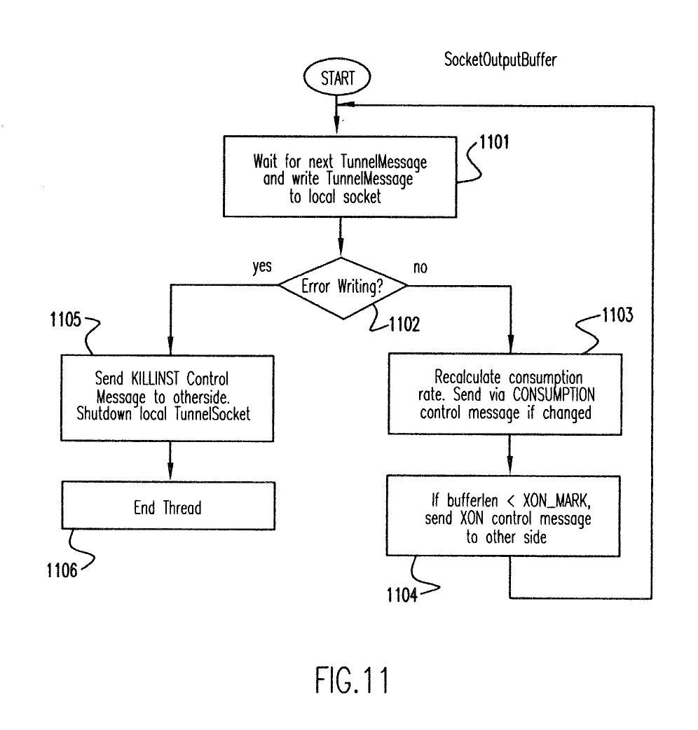

The SocketOutputBuffer process thread is shown in FIG. 11. The process waits for the next tunnel message in function block 1101, and then writes the TunnelMessage to the local socket. A determination is made in decision block 1102 as to whether there was an error in writing. If not, the consumption rate is recalculated in function block 1103. If the consumption rate has changed, then the recalculated rate is sent via the CONSUMPTION control message. If the buffer length is less than XON_MARK, and the socket was current marked XOFF, then an XON control message is sent to the other side in function block 1104. The process then returns to function block 1101.

Returning to decision block 1102, if there was an error in writing, a KILLINST control message is sent to the other side and the local tunnel socket is shut down in function block 1105. The thread is then ended in function block 1106.

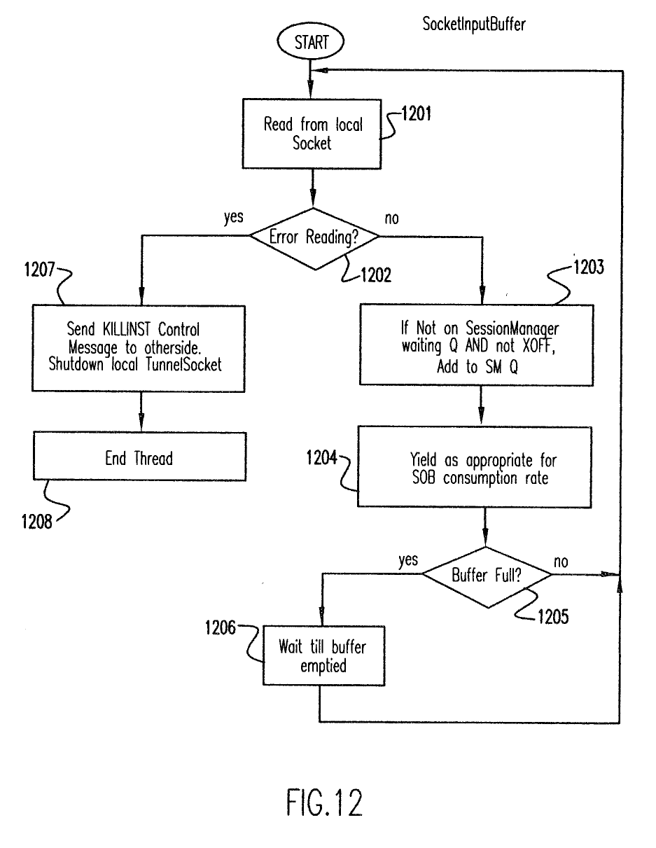

FIG. 12 shows the SocketInputBuffer process thread. The process begins with reading from the local socket in function block 1201. A determination is made in decision block 1202 if there was an error in reading. If not, then the tunnel message is added to the session manager queue in function block 1203 if not already in the session manager waiting queue and not XOFF. In function block 1204, allowance is made for the SocketOutputBuffer consumption rate. A test is made in decision block 1205 as to whether the buffer is full. If not, the process goes back to function block 1201; otherwise, the process waits until the buffer is emptied in function block 1206 before returning to function block 1201.

Returning to decision block 1202, if the there was an error in reading the tunnel message, a KILLINST control message is sent to the other side and the local tunnel socket is shut down in function block 1207. The thread is ended in function block 1208.

The tunneling method of the present invention essentially provides TCP proxy support on both the server and client sides. If the connectivity between these two proxies is interrupted (the client cannot create/maintain an HTTP or HTTPS connection to the server side), all of the client-side and server-side socket connections are maintained for a timeout period. The client will attempt to restore contact with the server side for the entire timeout period, and if successful, both sides will synchronize the data streams. This synchronization is possible, as both sides know the last record number successfully processed for each tunneled TCP connection, and thus, can retransmit any records not acknowledged as received by the other side. If the entire timeout period passes without the tunnel connection being restored, both the client side and server side will reclaim the resources allocated to that tunnel (e.g., close the local socket connections). In the case of the client, this means the end of its usefulness.

The preferred embodiment of the invention has been described in terms of a client-side application which will provide port forwarding. This client-side application can create ServerSockets to allow other client-side applications to connect to the server. Moreover, the client-side application will multiplex and demultiplex TCP data to and from the server, thus supporting many simultaneous TCP connections. As a variant of the preferred embodiment, the client-side tunneling application can allow server-side clients to access client-side resources, if desired. A further alternative embodiment could include a server-side tunneling application, which is embeddable inside a standard Web environment (as Common Gateway Interfaces (CGIs) or servlets). A server-side tunneling application would be similar to the client-side tunneling application as described with respect to the preferred embodiment and would be capable of multiplexing and demultiplexing TCP data to and from the client, thus supporting many simultaneous TCP connections.

Security is certainly a major concern when dealing with protocol flowing across a firewall. This invention employs a time-encoded cookie/token approach to authenticate and collate the POST/GET requests that emanate from the client, and terminate with the server. The cookie is replaced by the server every five minutes with a new time-encoded value, and has a ten minute life span. These values are arbitrary, and can easily be modified, but were selected as they were deemed to provide a reasonable token life both from a maintenance as well as a tunnel restart perspective. If the network between the client and server becomes unavailable, the client will still be able to reconnect with the last token value for at least 5, and up to 10 minutes from the time of network failure.

The cookie value is never in the clear from the time it leaves the client, to the time it arrives at the server, as its passed as a property, encapsulated in the HTTP request. So, the cookie validates the client to the server, while the HTTP server's SSL certificate validates the server to the client.

The initial time encoded token is obtained by the client during a login phase, where various authentication mechanisms can be employed to validate the user for login. The reference implementation uses a userid/password scheme to authenticate the user prior to allowing establishment of a tunnel and generation of the time-encoded cookie.

The preferred embodiment of the invention has been described in the environment of a client and a server behind separate firewalls; however, those skilled in the art will recognize that the fundamental teachings of the invention may be practiced in environments having but one or even no firewalls. The invention may be practiced in any environment where it is desired to establish a secure tunnel between any client and any server over a network. Also, while the description of the invention has focused on TCP as the targeted transport to be tunneled, it should be apparent to those skilled in the art that extensions to include other protocols, such as UDP (User Datagram Protocol), are a minor step forward. In fact, this tunneling technique ferries any data stream, the semantic of which need not be described to the captain. Minor modifications of the endpoints to support other transports (UDP for instance) could be plied, and the specific data need to unpack and retransmit could be folded into the data stream, as necessary. Therefore, those skilled in the art will recognize that the invention can be practiced with modification within the spirit and scope of the appended claims.

Having thus described our invention, what we claim as new and desire to secure by Letters Patent is as follows:

1. A packet switched network communications system comprising:
a first network including a client running at least one client application;
a second network including a server supporting a plurality of resources; and
a direct, port forwarding function implemented on the client for a tunnel operation in which a secure connection is made to the server.

2. The packet switched network communication system recited in claim 1, further comprising:
a firewall guarding computer resources of the first network and including an application or mechanism that enables connections from inside to outside the firewall.

3. The packet switched network communication system recited in claim 1, further comprising:
a firewall guarding computer resources of the second network and wherein the connection to the server is through a pre-determined HTTP (Hypertext Transfer Protocol) port in the firewall.

4. The packet switched network communication system recited in claim 1, further comprising:
a first firewall guarding computer resources of the first network and including an application or mechanism that enables connections from inside to outside the first firewall; and
a second firewall guarding computer resources of the second network and wherein the connection to the server is through a pre-determined HTTP (Hypertext Transfer Protocol) port in the second firewall.

5. The packet switched network communication system recited in claim 1, wherein the client maintains multiple URL (Universal Resource Locator) connections to server side servlets allowing data to flow in both directions between the client and the server.

6. The packet switched network communication system recited in claim 5, wherein the direct, port forwarding function is implemented in a client-side application providing port forwarding, the client-side application multiplexing and demultiplexing TCP (Transfer Control Protocol) data to and from the server so as to support a plurality of simultaneous TCP connections.

7. The packet switched network communication system recited in claim 5, wherein the client uses an HTTP POST request method to send data from the client to the server and the client uses an HTTP GET request method to allow data to be sent from the server to the client.

8. The packet switched network communication system recited in claim 1, wherein the direct, port forwarding function is implemented in a client-side application providing port forwarding.

9. The packet switched network communication system recited in claim 8, wherein the client-side application creates ServerSockets to allow other client-side applications to connect to the server.

10. The packet switched network communication system recited in claim 1, further comprising a client-side tunneling application which allows server-side clients to access client-side resources.

11. The packet switched network communication system recited in claim 1, further comprising a server-side tunneling application which is embeddable inside a standard Web environment.

12. The packet switched network communication system recited in claim 1, further comprising a server-side tunneling application which multiplexes and demultiplexes TCP (Transfer Control Protocol) data to and from the client so as to support a plurality of simultaneous TCP connections.

13. The packet switched network communication system recited in claim 1, further comprising a connectivity function wherein if the client cannot maintain a connection to the server, all of the client-side and server-side socket connections are maintained for a timeout period.

14. The packet switched network communication system recited in claim 13, wherein if the client restores contact with the server during the timeout period, the client and server synchronize their respective data streams and tunnelling continues.

15. The packet switched network communication system recited in claim 1, further comprising an authentication function on the client wherein a time-encoded token is used to authenticate requests that emanate from the client and terminate with the server.

16. The packet switched network communication system recited in claim 15, wherein the time encoded token is obtained by the client during a login phase, prior to allowing establishment of a tunnel.

17. In a packet switched network communications system including a first network including a client running at least one client application and a second network including a server supporting a plurality of resources, a first firewall guarding computer resources of the first network and including an application that enables connections from inside to outside the first firewall and a second firewall guarding computer resources of the second network and including an application that enables connection from inside to outside the second firewall, a method for tunneling implemented on the client for a tunnel operation in which a connection is made to a pre-determined HTTP (Hypertext Transfer Protocol) port in the second firewall comprising the steps of:
opening by the client a URL (Universal Resource Locator) connection to the server;
creating a tunnel message by the client and writing the tunnel message as data for a POST request;
reading by the server data from the POST request and acknowledging each tunnel message in response to the POST request;
creating by the server a tunnel message and writing tunnel messages to a response data stream; and
reading by the client the response data stream sent by the server in response to a GET request from the client.

18. A computer-readable storage medium accessible by a client in a packet switched network communications system including a first network including the client running at least one client application and a second network including a server supporting a plurality of resources, a first firewall guarding computer resources of the first network and including an application that enables connections from inside to outside the first firewall and a second firewall guarding computer resources of the second network and including an application that enables connection from inside to outside the second firewall, said storage medium having stored therein instructions for performing a method for tunneling in which a connection is made to a pre-determined HTTP (Hypertext Transfer Protocol) port in the second firewall, the method comprising the steps of:
opening by the client a URL (Universal Resource Locator) connection to the server;
creating a tunnel message by the client and writing the tunnel message as data for a POST request;
reading by the server data from the POST request and acknowledging each tunnel message in response to the POST request;
creating by the server a tunnel message and writing tunnel messages to a response data stream; and
reading by the client the response data stream sent by the server in response to a GET request from the client.
